(19) United States
(12) Patent Application Publication
(10) Pub. No.: US 2005/0251834 A1
(43) Pub. Date: Nov. 10, 2005

(54) Theater for user selected entertainment

(76) Inventor: William F. Hulbig, Norfolk, MA (US)

Correspondence Address: BANNER & WITCOFF, LTD., 28 STATE STREET, 28th FLOOR, BOSTON, MA, 02109-9601, US

(21) Appl. No.: 10/840,576

(22) Filed: May 6, 2004

(51) Int. Cl. H04N 5/445; H04N 7/18; G06F 13/00; G06F 3/00; H04N 9/31

(52) U.S. Cl. 725/78; 725/74; 348/744

(57) ABSTRACT

The present invention relates to a theater for user selected entertainment. The theater comprises a plurality of connected structures each adapted for rent by a user. Each structure includes a media playback device and a media reproduction device so that the user can select media and view such media in a home theater setting without the expense or cost of building a home theater. The theaters can be unmanned and can be configured to allow a user to select video or audio that is sent over a high speed broadband connection.

### FIELD OF THE INVENTION

The present invention relates to a theater for user selected entertainment. More particularly, the present invention relates to a home theater equivalent that can be rented by the user and can be used to play user selected media, such as digital video, for example.

### BACKGROUND OF THE INVENTION

Home theaters, that is, theaters built in private homes, are rapidly increasing as an entertainment choice. Numerous drawbacks exist, however, to home theaters. For example, installation of a home theater can be very costly. Large screen televisions or projectors can cost thousands or tens-of-thousands of dollars. Also, an expensive digital audio receiver and numerous speakers may be required to provide digital surround sound. In addition to the electronic equipment required for a home theater, an existing room of a house may need to be modified to provide suitable acoustics, wiring, and the like, to accommodate the home theater equipment and to provide suitable acoustic and viewing space. Dedicating a room of a house as a home theater also results in loss of useable space in the house.

To avoid building a home theater and still experience a theater-like environment, it is possible to view movies in a commercial theater. However, such commercial theaters require viewing of movies with other unknown and unfamiliar people and also do not provide a user with the ability to choose what movie the projectionist will show. While it may be possible to rent out an entire commercial theater to exclude unknown people, commercial theaters still do not provide access to the projection equipment and, in many cases, do not allow a user to view media which they bring to the theater.

It is an object of at least certain preferred embodiments of the present invention to provide a home theater equivalent that overcomes the disadvantages of commercial theaters and true home theaters. In particular, it is an object of the present invention to provide a commercial home theater equivalent that can be rented by a user and used by the user to playback user selected media, such as digital video, for example. These and other embodiments and versions of the invention of the invention are described in more detail below.

### SUMMARY OF THE INVENTION

In accordance with a first embodiment, a home theater equivalent for user selected entertainment is provided. The theater includes a plurality (i.e., two, three or more) of connected structures each adapted for rent by a user. Each of the structures is configured to provide a home theater like setting and includes a media playback device, a media reproduction device, a screen, and a plurality of seats. The media playback device may be any of innumerable devices suitable for playing user selected or user provided media such as, for example, DVDs, VCR tapes, digital camcorder videos, On-Demand cable programming, Pay-Per-View cable programming, and the like. The media playback device allows a user renting the theater to play media selected by the user. The media reproduction device may be any suitable device configured to receive a signal from the media playback device and reproduce that signal in a suitable manner to allow for viewing by the user. Exemplary media reproduction devices include but are not limited to projectors, televisions, and the like. The theater also includes one or more screens for receiving the signal outputted by the media reproduction device. Numerous screens and screen types are discussed below. The theater also includes a plurality of seats configured in a suitable arrangement for viewing the screen. In some versions of the invention discussed below, the seats may be reconfigured by the user, for example, moved to user selected positions. In certain versions of the invention, there are between about 5 and 30 seats.

In accordance with a second embodiment, a home theater equivalent for user selected entertainment is provided. The theater includes a plurality of interconnected structures each adapted for rent by a user. Each of the structures is configured to provide a home theater like setting and includes a DVD player, a DLP or LCD projector, a screen and a plurality of seats. In certain versions of the invention, the theater may include multiple screens, for example, one 16:9 screen and one 4:3 screen. The theater also included a plurality of seats configured in a suitable arrangement for viewing the screen. In some versions of the invention discussed below, the seats may be reconfigured by the user, for example, moved to user selected positions.

In certain versions of the invention, there are between about 5 and about 30 seats or between about 10 and about 20 seats to provide an intimate home theater setting. Preferred embodiments of the invention have 10-12 seats per theater, either fixed in place (e.g., as in a traditional theater) or movable (e.g., as with conventional furniture) or removable for making seating arrangements to suit the needs of the particular theater users. For example, handicap access to the home theater of the present invention can be easily accomplished by moving or removing selected seats from the theater.

In accordance with another embodiment, a method of renting a theater is provided. The method includes providing a theater for user selected entertainment, the theater comprising a scanner for scanning credit cards, debit cards, and the like. In certain versions of the invention, the user can swipe or scan their credit card using the scanner, and upon verification of the credit card, access to the theater can be granted. Access may be granted for a specific duration, for example, 4 hours or for an entire day or week, depending on the amount of time selected by the user.

In accordance with an additional embodiment, a method of renting a theater is provided. The method includes providing a theater for user selected entertainment, receiving a request by a user to rent the theater, and in response to the request received by the user generating a receipt that allows the user to access the theater. The request to rent the theater may be received by the user over the internet, by e-mail, by telephone, by facsimile or by other suitable transmission/reception devices. In at least certain versions of the invention described below, a receipt is automatically generated and sent back to the user. The receipt includes information, such as a bar code, keypad code, and the like, that allows the user to access the theater. Using this method, a user can automatically rent and gain access to a theater without speaking to a representative. Such automated rental of the theaters provides for decreased operating costs because no or few employees are required.

It will be recognized by the person of ordinary skill in the art that the theaters disclosed here represent a significant commercial advance. A user can experience a home theater environment without incurring the expense and modifications necessary to construct a theater in one's own home.

### BRIEF DESCRIPTION OF THE DRAWINGS

Certain versions of the invention or embodiments of the present invention are described in detail below with reference to the following figures in which:

FIG. 1 is an example of a theater comprising plurality of interconnected structures each available for rent by a user, in accordance with certain versions of the invention;

FIG. 2 is an example of a single theater suitable for rent by a user, in accordance with certain versions of the invention;

FIG. 3 is a side view of the theater shown in FIG. 2, in accordance with certain versions of the invention;

FIG. 4 is a side view of another example of a single theater, in accordance with certain versions of the invention;

FIGS. 5A and 5B are versions of the invention of mobile theaters, in accordance with certain versions of the invention;

FIG. 6 is an example of a method for renting a theater, in accordance with certain versions of the invention; and

FIG. 7 is another example of a method for renting a theater, in accordance with certain versions of the invention.

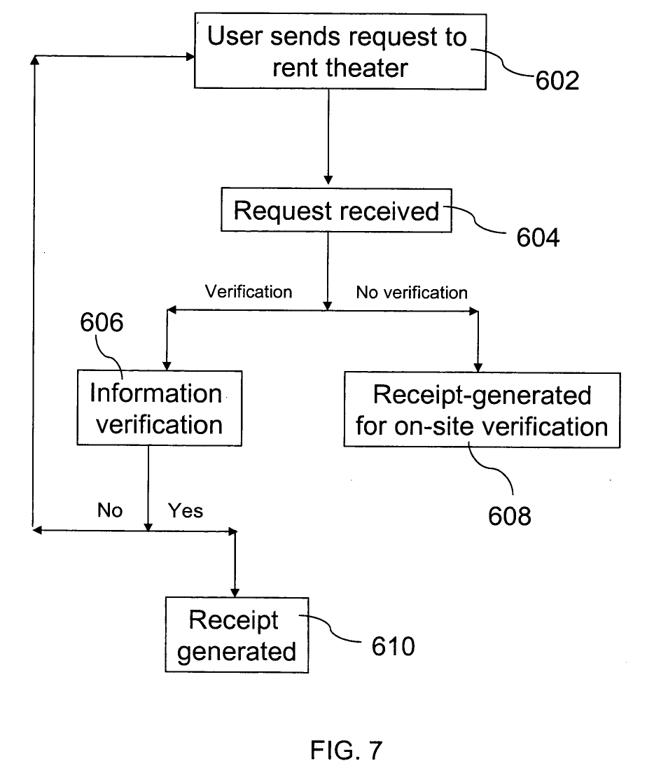

### DETAILED DESCRIPTION OF THE INVENTION

Certain non-limiting versions of the invention of a home theater equivalent for user selected entertainment are provided below. The person of ordinary skill in the art, given the benefit of this disclosure, will recognize that other versions of the invention and alterations, substitutions and modifications of the versions of the invention described below are possible. The versions of the invention described below serve to illustrate that the present invention provides a rentable home theater like setting without the high cost and drawbacks commonly associated with building a theater in one's own home.

In accordance with certain versions of the invention, the theaters disclosed here are designed to be rented by the general public and used by the public to play user selected media. As used here “user selected media” or “media selected by the user”refers to media that the user brings with them to the theater or selects once at the theater from commercially available sources such as, for example, broadcast television, cable television, satellite television, and the like. User supplied media is a subset of user selected media. “User supplied media” refers to media that the user brings with them to view or listen to in the rented theater. Such media may be selected by a user in numerous manners including, for example, on-demand media selections such as those offered by numerous cable companies, e.g., Comcast, Charter Communications, Cox Cable, Adelphia, and the like, pay-per-view media, such as that offered by cable companies and by satellite television providers, for example, DirectTV and Dish Network. In other versions of the invention, the user selects the media from a list of media in a digital library that can be located either on-site or off-site. Such media may be selected using a computer, for example, a desktop PC, laptop PC, and the like, or may be selected using an on-screen menu that appears upon entering the theater, for example.

In versions of the invention where the media library is located on-site, the media may take several forms. For example, the media can be VCR tapes or DVD discs or may be selected from digital media stored on a hard drive of a computer. In versions of the invention where the media library is off-site, the media can be streamed over the internet through a broadband connection, such as DSL, cable modem, T1, T3, and the like, to provide the media. Suitable methods for streaming video over the internet will be readily selected by the person of ordinary skill in the art, given the benefit of this disclosure.

In accordance with certain versions of the invention, the theaters disclosed here are configured for both video and audio. The video may be selected from numerous formats including NTSC, PAL, SECAM or may be selected from numerous digital formats including but not limited to AVI, MPEG-1, MPEG-2, MPEG-3, MPEG-4, DivX, XVid, ASF, or WMV. In certain versions of the invention, the audio is selected from one or more audio formats including but not limited to Dolby Pro-Logic I, Dolby Pro-Logic II, Dolby Digital 5.1, Dolby Digital 6.1, Dolby Digital 7.1, THX certified audio, THX surround EX, Dolby Digital EX, DTS, Neo, DTS-ES and other suitable audio formats that provide channel separation. In versions of the invention where audio is used, the audio may be selected from one or more of the following formats: WMA, MP3, MP3Pro, OGG, VQF, WAV or suitable digital audio formats. In certain other versions of the invention, the theaters may also be configured for graphics files. In versions of the invention where the media is a graphic file, the media format is selected from one or more of the following: .JPG, .GIF, .TIFF, .PCT, .BMP, .RAS, .WMF, .WPG, and .PCX. The person of ordinary skill in the art, given the benefit of this disclosure, will recognize that other video, audio and graphics formats are possible. While the theaters are configured for both audio and video, the user renting the theater may not want to use both the audio and video capabilities of the theater. For example, where the theater is rented to playback user selected audio, the video functions of the theater typically need not be used. The choice is up to the user.

In accordance with certain versions of the invention, the theater includes at least one media playback device. As used here the term “media” is used broadly and intended to include audio, video and graphic files. Such media may take numerous forms, e.g., analog and/or digital. In certain versions of the invention, the media is digital video, such as digital video that can be played using a DVD player, a DVD-ROM and/or one or more software programs. In versions of the invention using digital video, preferably the digital video is selected from one or more of the following formats: AVI, MPEG-1, MPEG-2, MPEG-3, MPEG-4, DivX, XVid, ASF, or WMV. Other suitable digital video formats will be readily selected by the person of ordinary skill in the art, given the benefit of this disclosure.

In certain versions of the invention, the media playback device has suitable algorithms and processing capabilities so that signals can be converted into a digital format in real time. The media playback device may also have suitable algorithms and processing software to upscale or up convert the video signal to a suitable resolution or embodiment ratio. In certain other versions of the invention, the media is loaded from one or more formats including but not limited to DVD discs, CD-ROMs, CD-RWs, CD-Rs, media saved on pen drives, media on floppy disks, Zip drives, Jazz drives, optical discs and the like. Such media can be loaded using the internal capabilities of the media playback device or by plugging in an external device that interfaces with the media playback device, for example, through a USB port, IR port, or fire wire port on the media playback device. It will be within the ability of the person of ordinary skill in the art, given the benefit of this disclosure, to select suitable media playback devices and devices that can interface with such media playback devices.

In accordance with other versions of the invention, the theaters disclosed here include one or more media reproduction devices. The media reproduction device may be any suitable device configured to receive a signal from the media playback device and reproduce that signal in a suitable manner to allow for viewing and/or listening by a user. The term “media reproduction device” is used in the broad sense and is intended to include electronic devices that are operative to receive a signal and decode or transform the signal, if necessary, into a viewable image or images and/or into a suitable audio signal. In at least certain versions of the invention, the media reproduction device is configured to provide a picture of sufficient size to provide adequate viewing by the person in the theater. For example, in setting where there are a small number of seats, for example, 5-10, the media reproduction device may be selected to provide a smaller picture, for example, 50-100 inch diagonal picture, whereas in versions of the invention where there are a large number of seats, for example, 30-50, the media reproduction device may be selected to provide a larger picture, for example, greater than 100 inches. The person of ordinary skill in the art will recognize, given the benefit of this disclosure, that suitable lenses can be used with the media reproduction devices disclosed here to increase or decrease the picture size. Exemplary lenses include but are not limited to short-throw lenses and long-throw lenses, and such lenses are commercially available from numerous manufacturers including the electronic manufacturers discussed herein. In certain versions of the invention, the media reproduction device is selected from a DLP projector, an LCD projector, a rear projection television, large screen computer monitors, direct view televisions, for example, those using cathode ray tubes, and the like. In certain versions of the invention, the media reproduction device is capable of producing an image having at least about 640×480pixel resolution, more preferably at least about 800×600 pixel resolution, and most preferably at least about 1024×768pixel resolution. Other suitable resolutions include but are not limited to 858×484 pixel resolution, 1386×788 pixel resolution, 1280×1024 pixel resolution, 1600×1200 pixel resolution, and the like. In some versions of the invention, the media reproduction device is capable of reproducing SDTV, EDTV, or HDTV signals. In some versions of the invention, the media reproduction device can output an RGB signal or a DVI signal, such as those received from a graphics card of a computer. The media reproduction device may also be configured with a high-bandwidth digital content protection (HDCP) port or a high-definition multimedia interface (HDMI) to provide high definition video and/or digital audio. The media reproduction device may include numerous algorithms to scale the signal to a selected or desired resolution, for example, 720 p or 788 p. Suitable media reproduction devices, such as LCD and DLP projectors, for example, are available commercially from numerous manufacturers including but not limited to Sony, Sanyo, Boxlight, InFocus, Epson, Hitachi, Panasonic, and other electronics manufacturers. In some versions of the invention, the media reproduction device is configured with one or more media slots, for example, Memory Stick Media slots, to playback still images. It will be within the ability of the person of ordinary skill in the art, given the benefit of this disclosure, to select suitable media reproduction devices for use in the theaters disclosed here.

In accordance with other versions of the invention, the theaters disclosed here also include one or more screens to receive the video or image outputted by the media reproduction device. The screen or screens are selected to provide suitable surfaces and embodiment ratios, for example, 4:3 or 16:9, for receiving the video or images. Suitable screens are commercially available from numerous manufacturers including but not limited to Da-Lite, Draper, Stewart, Vutec and The Screen Works. The exact dimensions of the screen may vary depending on the size of the video or image desired. Preferably, the screen is of sufficient size to provide at least about a 50 inch diagonal picture, more preferably at least about a 100 inch diagonal picture. In certain versions of the invention, the screen is about 8 feet wide and about 4.5 feet tall, whereas in other versions of the invention, the screen is about 16 feet wide and about 9 feet tall. The color of the screen may be selected such that dark colors, such as blacks, are reproduced faithfully even if the ambient light in the room is high. It will be within the ability of the person of ordinary skill in the art, given the benefit of this disclosure, to select suitable screens for the theaters disclosed here.

In accordance with certain other versions of the invention, the theaters disclosed here may include a stage at the front of the theater. The stage can serve multiple purposes. For example, in certain embodiments the stage is designed to prevent users from touching or interfering with the screen. In other versions of the invention, the stage is designed to provide a suitable area for theatrical productions and/or rehearsals. The stage may be elevated relative to the position of the seats and may include one or more sets of stairs for entering and exiting the stage. It will be within the ability of the person of ordinary skill in the art, given the benefit of this disclosure, to design suitable stages for use in the theaters disclosed here.

In accordance with certain versions of the invention, the theaters disclosed here may be constructed using suitable materials to provide substantial acoustic isolation to each of the theaters. As used here “acoustic isolation” refers to the condition where substantially no outside sounds can enter the theater. Acoustic isolation also refers to the condition where substantially no sounds generated inside the theater can exit the theater. In certain versions of the invention, acoustic materials, such as Soundboard commercially available from Celotex, acoustic foams, such as ProFoam, Hushfoam, and the like, gypsum board, such as that commercially available from US Gypsum, Owens-Coming, and the like, and other materials that provide high noise reduction coefficients are used in the interior and/or exterior walls of the theater. In certain versions of the invention, the theaters are constructed from multiple materials, such as a layer of gypsum board covered by one or more layers of acoustic foam. In at least some versions of the invention, the theaters are designed such that each theater of a multiplex is considered to be a “dead room” with substantially no sound exiting the room. In instances where the rooms are acoustically isolated, it may be necessary to provide fresh air inlets to prevent stale air in the theaters. Such fresh air can be provided through conventional HVAC systems. Preferably, the ductwork used with such HVAC systems provides minimal background noise to avoid disturbing the people in the theaters.

In accordance with certain versions of the invention, the theaters disclosed here may also include one or more lights. The lights typically are controlled by the user through one or more switches, for example, dimmer switches, so that the user can select the amount of lighting. In certain versions of the invention, the lights are recessed lights, such as can lights or pot lights.

In accordance with yet other versions of the invention, the theaters disclosed here may include a concession stand and one or more restrooms. In some versions of the invention, a concession stand may be positioned in each theater of the multiplex. In other versions of the invention, a single concession stand may be positioned central to the theaters of the multiplex. In certain versions of the invention, each theater of the multiplex has one or more restrooms, whereas in other versions of the invention, restrooms are located centrally in the multiplex and can be accessed by all users renting a theater. Other variations on placement of a concession stand and/or restrooms will be selected by the person of ordinary skill in the art, given the benefit of this disclosure.

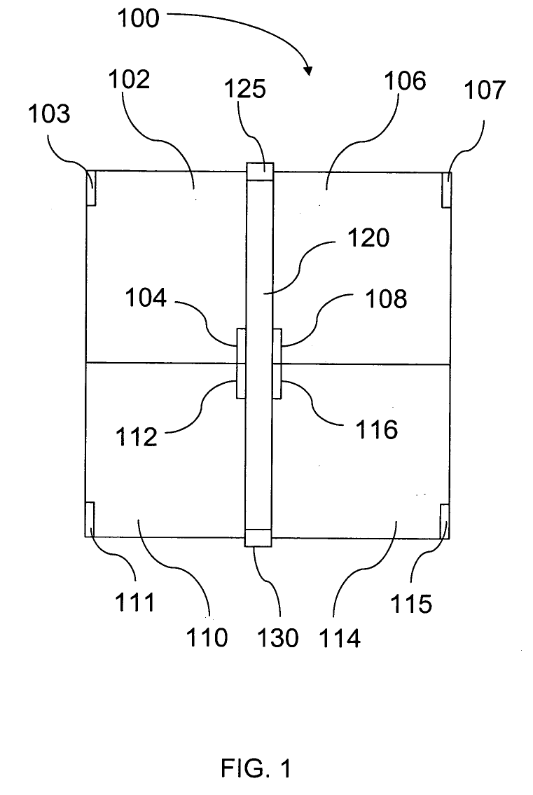

In accordance with certain versions of the invention, a multiplex theater for user selected entertainment is provided. The theater is a multiplex in that it includes a plurality of individual theaters that are physically connected. The theaters may be connected by sharing a wall or may be connected through one or more hallways. In some versions of the invention, the theaters are arranged with a single external entrance, and optionally one or more fire exits. Referring to FIG. 1, an example of a theater in accordance with certain versions of the invention of the present invention is shown. Multiplex theater 100 includes four connected theaters 102, 106, 110 and 114. Theater 102 includes an entrance 103 and an emergency exit 104. Likewise, theaters 106, 110 and 114 include entrances 107, 111, 115, respectively, and emergency exits 108, 112, and 116, respectively. Emergency exits 104, 108, 112 and 116 are connected to hallway 120 which includes two exits 125 and 130. In certain versions of the invention, hallway 120 may be omitted and the emergency exits can be positioned on an outer wall to provide for emergency exiting of the structure. In cities or locales where no emergency exits are required by local code, the emergency exits may be omitted entirely.

In accordance with certain versions of the invention, two or more of the theaters disclosed herein may be linked together, that is, connected so as to share the same audio and/or video output. In this embodiment of the invention, large groups, that otherwise would not be able to occupy a single home theater comfortably, can occupy more than one theater and enjoy the same audio and/or video presentation at the same time as other connected theater groups. This example of the invention is ideal for training sessions, product demonstrations, conventions, and other large group settings.

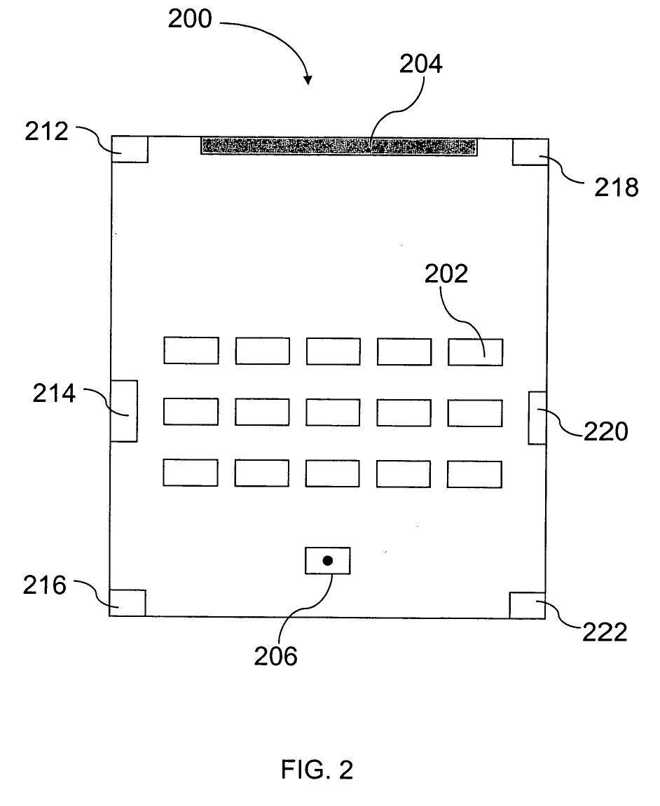

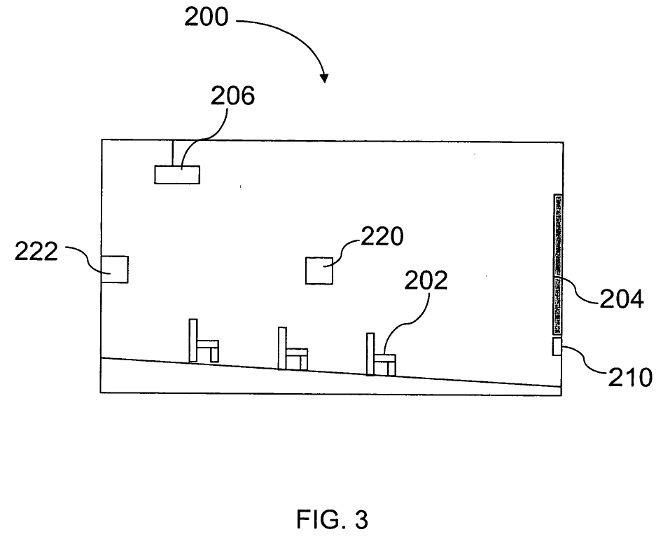

In accordance with certain versions of the invention and referring to FIGS. 2 and 3, an individual theater of the multiplex theater is shown with the entrance and any exits omitted. Theater 200 includes a plurality of seats, such as seat 202. In certain versions of the invention, the seats are arranged at different heights such that the view of persons sitting towards the back of the theater is not obstructed by persons sitting towards the front of the theater. Theater 200 includes screen 202, which receives the output from projector 206 (see FIG. 3). Theater 200 also includes a plurality of speakers for outputting audio. In the example shown in FIGS. 2 and 3, theater 200 includes front center speaker 210, front left and right speakers 212 and 218, respectively, surround left and surround right speakers 214 and 220, respectively, and surround back left and surround back right speakers 216 and 222, respectively. One or more subwoofers (not shown) are also included in the theater for outputting low frequency signals, for example, those below about 200, 100 or 50 Hz. In the configuration shown in FIGS. 2 and 3, theater 200 is configured for 7.1 channel audio. The person of ordinary skill in the art will recognize, given the benefit of this disclosure, that fewer speakers may be used to configure the theater for 6.1 or 5.1 channel audio. Such audio configurations will be readily selected by the person of ordinary skill in the art, given the benefit of this disclosure. The exact placement, for example, height from the floor, and orientation of the speakers may vary depending on the shape and size of the theater and upon the desired audio effect to be provided in the theater. The speakers are typically connected to a digital audio receiver which decodes an audio signal and transmits an appropriate signal to an appropriate speaker to provide digital surround sound. Exemplary digital audio receivers are commercially available from numerous manufacturers including but not limited to Sony, Yamaha, Onkyo, Denon, Harmon Kardon and other electronic manufacturers.

In accordance with other versions of the invention, projector 206 is preferably a DLP projector or an LCD projector. Projector 206 is positioned a suitable distance from screen 204 such that the image projected onto screen 204 fills the screen. This distance typically depends on the screen size and throw distance of the projector. Preferably, the distance and screen are selected so that at least about a 100 inch diagonal picture is projected onto the screen. In certain versions of the invention, projector 206 is in communication with a media playback device, such as a DVD player (not shown). Suitable interconnects for transmitting the signal between the media playback device and the projector will be readily selected by the person of ordinary skill in the art, given the benefit of this disclosure. Exemplary interconnects include but are not limited to composite cables, component video cables, S-video cables, RGB cables, DVI cables and the like. The length of the interconnects will vary depending on the placement of the media playback device and media reproduction device. In certain versions of the invention, the interconnects are run through the walls and ceiling of the theater to avoid unsightly cable runs. In other versions of the invention, projector 206 is in communication with the media playback device and an audio receiver. In the case where multiple media playback devices and/or multiple projectors are used, the audio receiver can be used to switch between different projectors and/or different media playback devices. It will be within the ability of the person of ordinary skill in the art, given the benefit of this disclosure, to select suit and configure the media playback devices, projectors and audio receivers used in the theaters disclosed here.

In accordance with certain other versions of the invention, the screen may take various sizes and shapes. In at least certain versions of the invention, the screen has a 16:9 embodiment ratio, whereas in other versions of the invention, the screen has a 4:3embodiment ratio. In at least certain versions of the invention, theater 200 may include two or more screens, for example, one 16:9 embodiment ratio screen and one 4:3embodiment ratio screen, to accommodate the desired media selected by the user. In certain versions of the invention, the screen or screens are preferably retractable. In particular, in versions of the invention where the theater includes a stage, the screen can be retracted to provide more space for theatrical productions. Numerous retractable screens are commercially available from Da-Lite, Draper, Stewart and other screen manufacturers. In versions of the invention where the theater includes a retractable screen, the user may select whether to extend or retract the screen.

In accordance with certain other versions of the invention, the seats in the example shown in FIGS. 2 and 3 are positioned at an incline to provide better viewing for persons seated towards the rear of the theater. The exact angle of incline is not critical and may be selected based on seat positioning and other factors such as theater height and width, for example. The exact configuration of the seats is not critical and in certain versions of the invention, the seats may be configured in linear rows, in a semi-circular pattern or other suitable configurations. In some versions of the invention, the seats may be reconfigured by the user, for example, moved to user selected positions. In certain versions of the invention, there are between about 5 and about 40 seats, more preferably between about 10 and about 30 seats and most preferably between about 10 and about 20 seats.

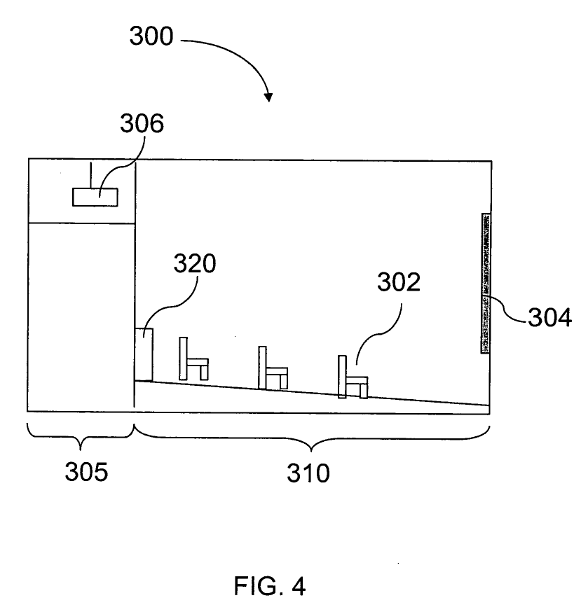

In accordance with certain other versions of the invention, another example of a theater is shown in FIG. 4. In this example, theater 300 includes a projection room 305 separated from viewing room 310. It may be advantageous to separate the projection room from the viewing room to prevent the user from interfering with or damaging the projector. In versions of the invention where the projection room is separated from the viewing room, the media playback device may still be user accessible so that the user can select media to be played. For example, referring to FIG. 4, projection room 305 contains projector 306 and is separated from viewing room 310. Cabinet 320, which contains a media playback device, is still user accessible, however. Theater 300 also includes a plurality of seats, such as seat 302, and screen 304. The projection room can be designed so that it is only accessible by the theater owner or can be designed so that it is accessible by the user renting the theater. In certain versions of the invention, it may be advantageous to separate the viewing room and the projection room to reduce noise levels, for example, noise resulting from the projector or one or more fans designed to cool the projector. Projection room 305 preferably includes substantially optically transparent glass so that the image projected is not distorted or altered by placement of the projector in the projector room. In certain versions of the invention, a small hole or opening exists so that the projector image does not pass through any glass or other material in the projection room. It will be within the ability of the person of ordinary skill in the art, given the benefit of this disclosure, to design suitable projection rooms and suitable theaters including projection rooms.

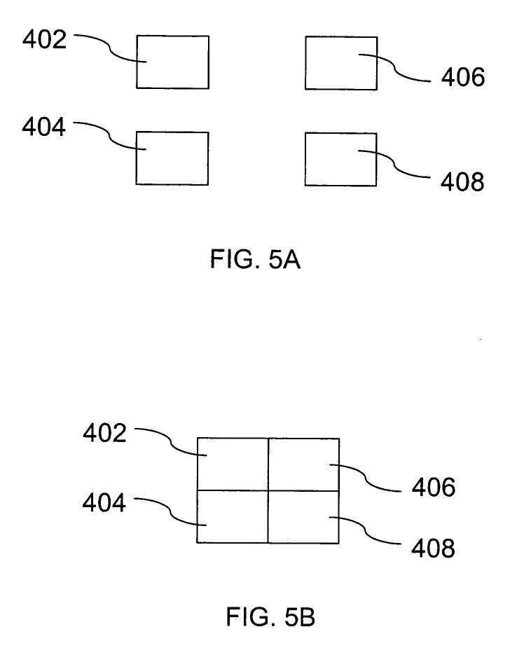

In accordance with certain other versions of the invention, the theaters can be constructed such that they are mobile. One such example of a mobile theater is shown in FIG. 5A. First mobile theater 402 typically includes a the components described above in reference to FIGS. 1-4, for example, a media playback device, a media reproduction device, a screen and a plurality of seats. The mobile theater can be rented using the methods described below and can be delivered to a site on the back of a tractor-trailer, for example. The mobile theater can be removed from the tractor-trailer and placed at a suitable location on the user's premises. In certain other versions of the invention, additional mobile theaters 404, 406 and 408 can be attached to first mobile theater 502 to form a multiplex theater that can be periodically moved from location to location. For example, referring to FIG. 5B, theaters 402, 404, 406 and 408 have been placed together to form a multiplex theater available for rent by users. The mobility of the theaters provides for the ability to rapidly and fully assemble the theaters off-site and deliver assembled theaters to a location so that they can be rented almost immediately upon delivery.

In accordance with certain versions of the invention and as discussed further below, the theaters can be rented over the internet, by phone, by electronic mail, or by other means that can be automated, for example. It is a significant advantage that the theaters can be rented using automated methods in order to reduce operating costs and provide cheaper rental rates. In other versions of the invention, the theaters are rented by payment of a fee to an attendant who then provides access to the theater. These and other suitable methods for renting the theaters disclosed here are provided below. The theaters may be rented for numerous periods. For example, a user may rent a theater for a few hours, for half a day, for an entire day, for several days, for a week, and the like. Upon expiration of the rental period, the theater can be designed so that the media playback device and/or media reproduction device powers down. In other versions of the invention, upon expiration of the rental period the lights turn on automatically and in such a manner that the images on the screen cannot be satisfactorily viewed. In yet other versions of the invention, upon expiration of the rental period, an attendant ushers the user(s) out of the theater. Other possible methods of preventing use of the theater beyond the rental period will be recognized by the person of ordinary skill in the art, given the benefit of this disclosure.

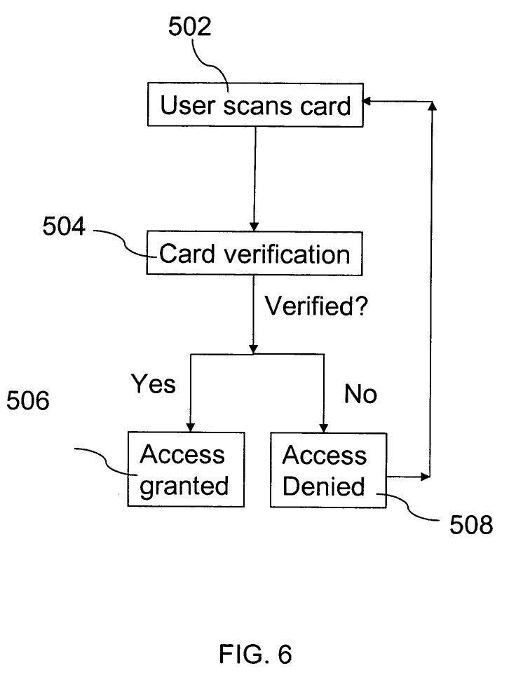

In accordance with certain other versions of the invention, a method of renting a theater is provided. The method includes providing a theater for user selected entertainment, the theater comprising a scanner for scanning credit cards, debit cards, and the like. The user can swipe or scan their credit card using the scanner, and upon verification of the credit card, access to the theater can be granted. Access may be granted for a specific duration, for example, four (4) hours or for an entire day or week, depending on the amount of time selected by the user. An example of renting a theater on-site is shown in FIG. 6. In this example, the user can rent the theater simply by going to the theater and paying the selected rental rate. A user scans a card 502, such as a credit card or debit card. The credit card or debit card is verified or authenticated 504 to ensure that a sufficient fee can be charged to the card. If the card is verified, then access to the theater 506 is granted. In the event that the card is not verified, access is denied 508 and the user is invited to scan or swipe another card. This method of renting a theater allows a user to rent the theater without any reservations and without any on-site attendant.

In accordance with other versions of the invention, a method of renting a theater is provided. The method includes providing a theater for user selected entertainment, receiving a request by a user to rent the theater, and in response to the request received by the user generating a receipt that allows the user to access the theater. The request to rent the theater may be received by the user over the internet, by e-mail, by telephone, by facsimile or by other suitable transmission/reception devices. In at least certain versions of the invention described below, a receipt is automatically generated and sent back to the user. The receipt includes information, such as a bar code, keypad code, and the like, that allows the user to access the theater. Using this method, a user can automatically rent and gain access to a theater without speaking to a representative. In certain versions of the invention, the receipt contains a bar code that is read by a bar code scanner attached to the theater. If the bar code matches the allowed bar codes, then the user is provided access to the theater for a predetermined rental period. In other versions of the invention, the user rents the theater and an access card is mailed to the user to provide access to the theater. Other suitable methods of renting the theaters will be readily selected by the person of ordinary skill in the art, given the benefit of this disclosure. One such exemplary method is shown in FIG. 6. A user sends a request to rent the theater 602. The request is received 604 by a computer. The request typically contains identification information, for example, the user's name, address, phone number, and the like, and may also contain credit card or debit card information. For security purposes the request is typically encrypted in transit and decrypted upon arrival at the computer. The computer contains suitable algorithms and software, for example, software commercially available from numerous manufacturers including but not limited to Xequte, Main Street Softworks, Inc., CCVS software for Linux, and the like, to verify the credit card information 606. If the credit card information is verified, a receipt 610 is sent back to the user and can be printed out and taken to the theater for access to the theater. The receipt may contain bar code or keypad access code to provide access to the theater. In versions of the invention where the receipt contains a bar code, the theater may further contain a bar code scanner to read the bar code. In certain versions of the invention, the receipt contains a bar code with time and date information such that the user only gains access to the theater at that specified time and on that specified date. If the credit card is not verified, a request inviting the user to submit a new credit card number is sent to the user. In certain versions of the invention, no credit card information is submitted to rent the theater. Instead, the user rents the theater, receives a receipt, and gains access to the theater only by providing suitable credit card information on-site 608.

In accordance with certain versions of the invention, once the user has gained access to the theater, the user can play selected media. In some versions of the invention, the user brings the media with them to the theater, for example, in the form of a DVD disc. In other versions of the invention, the user orders media over a phone, cable or internet connection. For example, the theaters can be installed with a credit card scanner so that a user can order digital video through a pay-per-view service such as those provided by cable companies and satellite providers. Such video can be streamed from a remote site and viewed in the theater. In certain versions of the invention, the theaters are configured with suitable electronic devices to allow the user to pause the streaming video, fast forward the streaming video, and/or rewind the streaming video. In other versions of the invention, the entire video and/or audio file is downloaded to the theater and then is played back using the media playback device and projected on screen using the media reproduction device. In some versions of the invention, the media is ordered at the same time the user rents the theater, whereas in other versions of the invention, the media is ordered on-site and after the user has gained access to the theater. Other suitable methods by which the user may select media will be recognized by the person of ordinary skill in the art, given the benefit of this disclosure.

Although certain versions of the invention have been described above, other versions of the invention and alterations, modifications and substitutions of those versions of the invention will be recognized by the person of ordinary skill in the art, given the benefit of this disclosure. The following claims are intended to cover such alterations, modifications and substitutions.

1. A theater for user selected entertainment, the theater comprising:
a plurality of connected structures each adapted for rent by a user, each of the plurality of connected structures comprising:
at least one media playback device configured to play media selected by the user renting a structure;
at least one media reproduction device in communication with the media playback device;
a screen configured to receive an output signal from the media reproduction device; and
a plurality of seats configured to view the screen.

2. The theater of claim 1 in which the connected structures are unmanned.

3. The theater of claim 1 in which there are between 2 and 10 connected structures.

4. The theater of claim 1 in which there are between about 10 and about 30 seats.

5. The theater of claim 1 in which the seats can be arranged by the user.

6. The theater of claim 1 in which the media playback device is configured to play digital video.

7. The theater of claim 6 in which the digital video is selected from AVI, MPEG-1, MPEG-2, MPEG-3, MPEG-4, DivX, XV

8. The theater of claim 1 in which the media reproduction device is a LCD projector or a DLP projector.

9. The theater of claim 1 in which the media reproduction device is a digital receiver configured to output digital sound.

10. The theater of claim 9 further comprising one or more speakers for outputting the digital sound.

11. The theater of claim 8 further comprising a digital receiver configured to output digital sound.

12. The theater of claim 11 further comprising one or more speakers for outputting the digital sound.

13. The theater of claim 1 in which the theater further comprises a concession stand.

14. The theater of claim 1 in which the theater comprises one or more restrooms.

15. The theater of claim 1 in which the plurality of connected structures are mobile.

16. The theater of claim 1 in which each of the plurality of connected structures is a mobile theater.

17. A theater for user selected entertainment, the theater comprising:
a plurality of connected structures each adapted for rent by a user, each of the plurality of connected structures comprising:
at least one DVD player or VCR player configured to play media supplied by the user renting a structure;
at least one projector in communication with the DVD player of VCR player;
a screen configured to receive an output signal from the projector; and
a plurality of seats configured to view the screen.

18. The theater of claim 17 in which the projector is a DLP projector or an LCD projector.

19. The theater of claim 17 in which there are between about 10 and about 30 seats.

20. The theater of claim 17 in which the plurality of seats may be arranged by the user renting the structure.

21. A method of providing user selected entertainment, the method comprising:
providing a theater for rent by a user, the theater being part of a larger group of connected theaters, the theater comprising
at least one media playback device configured to play media selected by the user renting the theater,
at least one media reproduction device in communication with the media playback device,
a screen configured to receive an output signal from the media reproduction device,
a plurality of seats configured to view the screen; and
renting the theater to the user.

22. The method of claim 21 in which the structure is rented over the internet.

23. The method of claim 22 in which renting the structure over the internet comprises:
sending a request over the internet to rent theater;
receiving a receipt over the internet confirming rental of the theater.

24. The method of claim 21 in which the media selected by the user is supplied over the internet.

25. The method of claim 21 in which the media selected by the user is streamed from a remote site selected by the user.

26. The method of claim 21 in which the media selected by the user is retrieved from an on-site digital library.

27. A method of providing user selected entertainment, the method comprising:
providing a theater for rent by a user, the theater comprising
at least one DVD player or VCR player configured to play media.selected by the user renting the theater,
at least one projector in communication with the DVD player or the VCR player,
a screen configured to receive an output signal from the at least one projector,
a plurality of seats configured to view the screen; and
renting the theater to the user.

28. The method of claim 27 in which renting the structure comprises
sending a request to rent theater;
receiving a receipt confirming rental of the theater.

29. The method of claim 28 in which the request to rent the theater is sent over the internet.

30. The method of claim 28 in which the receipt confirming rental of the theater is received over the internet.

31. The method of claim 27 in which the media selected by the user is streamed over from a remote site selected by the user.

32. The method of claim 27 in which the media selected by the user is retrieved from an on-site digital library.
